(19) United States
(12) Patent Application Publication
(10) Pub. No.: US 2016/0234320 A1
(43) Pub. Date: Aug. 11, 2016

(54) SYSTEM, DEVICE, AND METHOD FOR ACCESSING CROSS-PLATFORM SERVICE

(71) Applicant: MediaTek Inc., Hsin-Chu (TW)

(72) Inventors: Yu-Cheng CHANG, Chiayi City (TW); Shu-Hsin CHANG, Hsinchu City (TW); Chun-Hsiung HU, Hsinchu City (TW); JenChieh LO, Zhushan Township (TW)

(21) Appl. No.: 14/943,363

(22) Filed: Nov. 17, 2015

Related U.S. Application Data
(60) Provisional application No. 62/114,252, filed on Feb. 10, 2015.

(51) Int. Cl. H04L 29/08; H04L 29/06

(52) U.S. Cl. CPC H04L 67/16; H04L 67/02; H04L 67/42

(57) ABSTRACT

A communications system for accessing a cross-platform service is provided. The communications system includes a first communication device including a service demander and a second communication device including a service provider. The service demander transmits an advanced device information request to a second communication device for requesting advanced device information according to an IP address of the second communication device via a network. The service provider transmits a device information response including the advanced device information to the service demander of the first communication device, wherein the advanced device information at least includes a service list.

### CROSS REFERENCE TO RELATED APPLICATIONS

This application claims priority of U.S. Provisional Patent Application No. 62/114,252, filed on Feb. 10, 2015, the entirety of which is incorporated by reference herein.

### BACKGROUND OF THE INVENTION

1. Field of the Invention

This disclosure generally relates to communications applications, and more particularly, to a communications system, a communication device and a method for accessing a cross-platform service.

2. Description of the Related Art

As the popularity of mobile devices has grown, many different types of computing devices have become available to users. Those mobile devices may operate on different operating platforms, each platform having its own specifications, libraries, etc. As a result, a mobile application that can be executed on one operating platform is often not compatible with other operating platforms.

Traditionally, an application developer predefines how a mobile device using a mobile application accesses a cross-platform service, such as an application, a service and so on, from other devices when designing the mobile application. Often, the mobile application must be both installed in the mobile device at the user side, and the other device at the server side so that the mobile device can access the cross-platform service from the other device.

Accordingly, there exists a need for a system, a device, and method that allows users, regardless of their mobile device or platform, to access the cross-platform service from the other device without installing the mobile application on the operating platform of the mobile device.

### BRIEF SUMMARY OF THE INVENTION

In a preferred embodiment, the invention is directed to a communications system for accessing a cross-platform service. The communications system comprises a first communication device comprising a service demander and a second communication device comprising a service provider. The service demander transmits an advanced device information request to the second communication device for requesting advanced device information according to an IP address of the second communication device via a network. The service provider transmits a device information response including the advanced device information to the service demander of the first communication device, wherein the advanced device information at least includes a service list.

In some embodiments, the second communication device further comprises an application mapping to a service recorded in the service list. The service demander transmits a launch request to the second communication device for launching the service; the service provider launches the application mapped to the service, transmits application-launching information to the application, and transmits service-launching information to the service demander of the first communication device; and the service demander launches the service according to the service-launching information. In some embodiments, the service-launching information at least includes a uniform resource locator (URL) and parameters of the service. In some embodiments, the second communication device further comprises a Web server. The application starts the Web server and transmits the application-launching information to the Web server. In some embodiments, the service provider further generates the service-launching information according to registration information received from the application during an application registration procedure before transmitting the service-launching information. In some embodiments, the service provider generates the service-launching information according to application return information transmitted by the application before transmitting the service-launching information. The application return information at least includes the URL and the parameters of the service. In some embodiments, the service demander opens a browser to access the service according to the URL after receiving the service-launching information. In some embodiments, after the service provider launches the application, the application generates the service-launching information and transmits the service-launching information to the service provider. The service-launching information at least includes a launch path and parameters of the service. In some embodiments, after the service provider transmits the service-launching information, the service demander starts up a first application to access the service according to the launch path and transmits the service-launching information and the IP address of the second communication device to the first application; the first application establishes a network connection with the application of the second communication device according to an IP address of the first communication device and the IP address of the second communication device to launch the service through the first application. In some embodiments, the application-launching information at least includes launch parameters and an IP address of the first communication device. In some embodiments, the service list includes a list of services mapped to respective applications.

In a preferred embodiment, the invention is directed to a communication device for accessing a cross-platform service. The communication device comprises a memory and a processor comprising a service provider. The service provider detects that an application is installed in the communication device, checks whether application information of the application contains pre-defined information, and performs an application registration procedure after checking that the application information of the application contains the pre-defined information.

In some embodiments, the application registration procedure performed by the service provider further comprises: launching the application for registration; and receiving registration information from the application via a registration interface, wherein the registration information comprises device/service information used to register the application. In some embodiments, the pre-defined information at least comprises a uniform resource locator (URL), a uniform source identifier (URI), or header information. In some embodiments, the application registration procedure performed by the service provider further comprises: detecting that the application is removed from the communication device; checking whether the application information of the application contains the pre-defined information; and removing the application information and the registration information after checking that the application information of the application contains the pre-defined information.

In a preferred embodiment, the invention is directed to a method for accessing a cross-platform service, used in a communications system. The method comprises: transmitting, by a service demander of a first communication device, an advanced device information request to a second communication device for requesting advanced device information according to an IP address of the second communication device via a network; and transmitting, by a service provider of the second communication device, a device information response including the advanced device information to the service demander of the first communication device, wherein the advanced device information at least includes a service list.

In a preferred embodiment, the invention is directed to a method for accessing a cross-platform service, used in a communication device. The method comprises: detecting that an application is installed in the communication device; checking whether application information of the application contains pre-defined information; and performing an application registration procedure when checking that the application information of the application contains the pre-defined information.

In a preferred embodiment, the invention is directed to a method for accessing a cross-platform service, used in a communication device. The method comprises: transmitting an advanced device information request to a second communication device for requesting advanced device information according to an IP address of the second communication device via a network; receiving a device information response including the advanced device information from the second communication device, wherein the advanced device information at least includes a service list; transmitting a launch request to the second communication device for launching a service recorded in the service list; receiving service-launching information from the second communication device; and launching the service according to the service-launching information.

In a preferred embodiment, the invention is directed to a method for accessing a cross-platform service, the method being used in a communication device. The method comprises: receiving an advanced device information request from a first communication device for requesting advanced device information via a network; transmitting a device information response including the advanced device information to the first communication device, wherein the advanced device information at least includes a service list; receiving a launch request from the first communication device for launching a service recorded in the service list; launching an application mapped to the service and transmitting application-launching information to the application; and transmitting service-launching information to the service demander of the first communication device.

### BRIEF DESCRIPTION OF DRAWINGS

The invention can be more fully understood by reading the subsequent detailed description and examples with references made to the accompanying drawings, wherein:

FIG. 1 is a block diagram of a communications system according to an embodiment of the invention.

FIGS. 2A˜2B are simplified functional block diagrams respectively illustrating the structures of the first communication device and the second communication device in FIG. 1 according to an embodiment of the present invention.

FIG. 3 is a flow diagram illustrating a method for registering an application according to an embodiment of the present invention.

FIG. 4 is a flow diagram illustrating the steps of performing an application registration procedure according to an embodiment of the invention.

FIG. 5 is a flow diagram illustrating the steps of removing an application registration procedure according to an embodiment of the invention.

FIG. 6 illustrates a procedure for cross-platform applications performed between a first communication device and a second communication device with reference to the communications system in FIG. 1 and the communication devices in FIGS. 2A˜2B according to an embodiment of the invention.

FIG. 7 illustrates a procedure for launching cross-platform applications performed between a first communication device and a second communication device with reference to the communications system in FIG. 1 and the communication devices in FIGS. 2A˜2B according to an embodiment of the invention.

FIG. 8 illustrates a procedure for launching cross-platform applications performed between a first communication device and a second communication device with reference to the communications system in FIG. 8 and the communication devices in FIGS. 2A˜2B according to an embodiment of the invention.

FIG. 9 is a flow diagram illustrating the second communication device publishes the service to the first communication device according to an embodiment of the invention.

FIG. 10 is a flow diagram illustrating a method for accessing a cross-platform service according to an embodiment of the invention.

FIG. 11 is a flow diagram illustrating a method for accessing a cross-platform service according to an embodiment of the invention.

FIG. 12 is schematic diagram illustrating how a mobile phone used by a user accesses the service of a TV through a browser according to an embodiment of the invention.

### DETAILED DESCRIPTION OF THE INVENTION

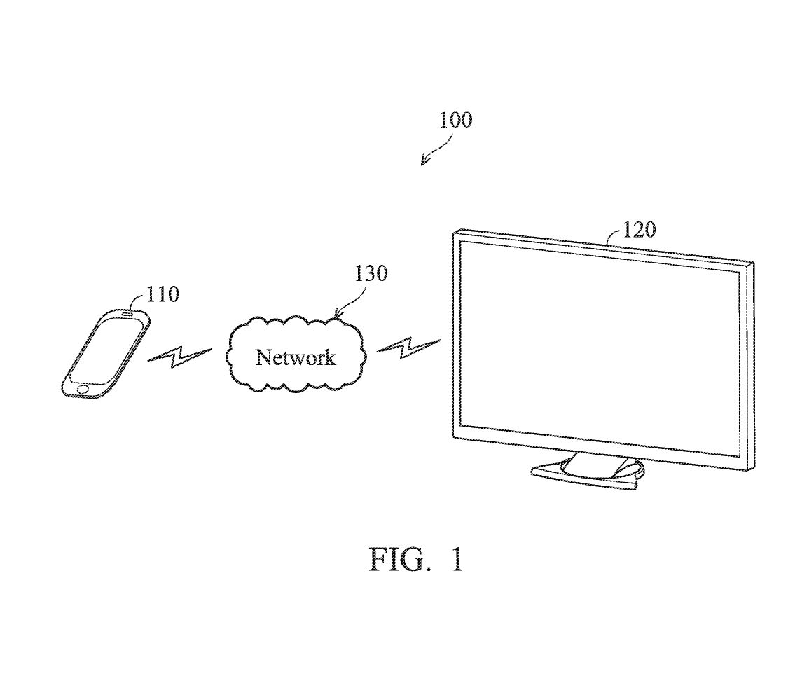

Several exemplary embodiments of the present disclosure are described with reference to FIGS. 1 through 10, which generally relate to a communications system, a communication device, and a method for accessing a cross-platform service. It should be understood that the following disclosure provides various embodiments as examples for implementing different features of the present disclosure. Specific examples of components and arrangements are described in the following to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various described embodiments and/or configurations.

FIG. 1 is a block diagram of a communications system 100 according to an embodiment of the invention. The communications system 100 allows for transmitting, receiving, and storing data between multiple communication devices. The communications system 100 includes a first communication device 110 at a service-demander side, a second communication device 120 at a service-provider side, and a network 130. The network 130 may be any network or combination of networks that can carry data communication. Such a network 130 may include, but is not limited to, a local area network, metropolitan area network, and/or wide area network such as the Internet. The network 130 can support protocols and technologies including, but not limited to, World Wide Web protocols and/or services. Intermediate web servers, gateways, or other servers may be provided between components of the communications system shown in FIG. 1 depending upon a particular application or environment.

The first communication device 110 and the second communication device 120 may be any device under control of a user and are capable of requesting and receiving data with each other via the network 130. For example, the first communication device 110 and the second communication device 120 can be a mobile phone, a TV, and so on. Although the first communication device 110 and the second communication device 120 is represented as a mobile phone and a TV in FIG. 1, it will be appreciated by those of skill in the art that the invention is not limited to the mobile phone and the TV.

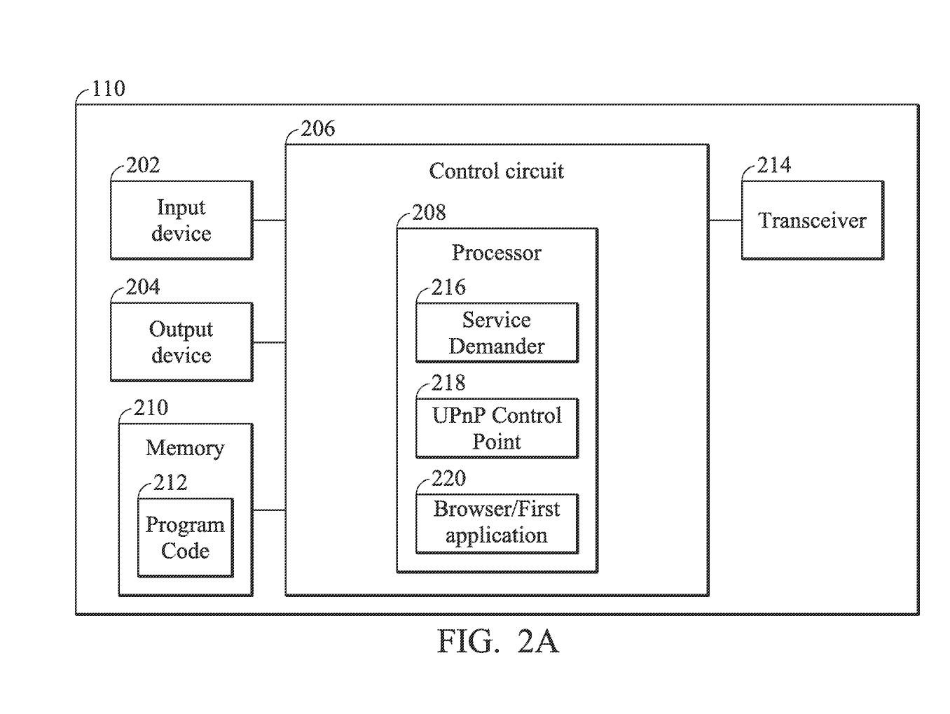

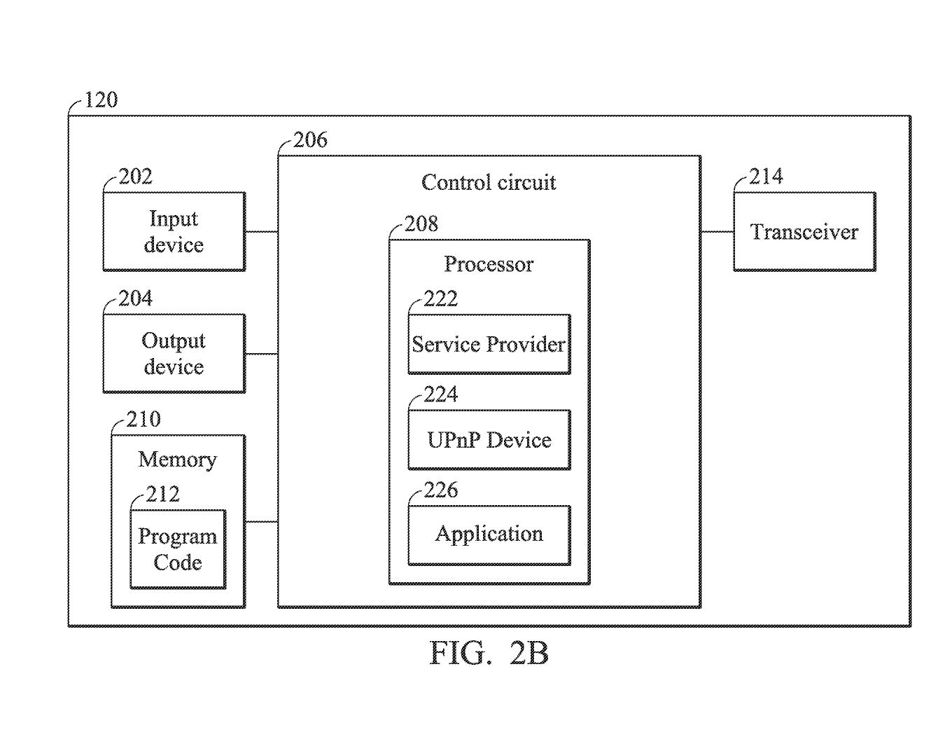

FIGS. 2A˜2B are simplified functional block diagrams respectively illustrating the structures of the first communication device 110 and the second communication device 120 in FIG. 1 according to an embodiment of the present invention. The first communication device 110 and the second communication device 120 may both include an input device 202, an output device 204, a control circuit 206, a processor 208 (which may be referred to as a central processor unit (CPU)), a memory 210, a program code 212, and a transceiver 214. The control circuit 206 executes the program code 212 in the memory 210 through the processor 208, thereby controlling an operation of the first communication device 110 and the second communication device 120. The first communication device 110 and the second communication device 120 can receive signals input by a user through the input device 202, such as a keyboard, touch screen, or keypad, and can output images and sounds through the output device 204, such as a monitor or speakers. The transceiver 214 is used to receive and transmit wireless signals, delivering received signals to the control circuit 206, and outputting signals generated by the control circuit 206 wirelessly.

In FIG. 2A, the processor 208 may further comprise a service demander 216, a universal plug and play (UPnP) control point 218, and a browser/first application 220. The service demander 216 can be used in a communication device at the service-demander side to request other communication device at the service-provider side to launch a cross-platform service. The UPnP control point 218 is used to find other communication device by transmitting a Multicast-search (M-search) message. The browser/first application 220 can be used to access the service of the communication device at the service-provider side. In FIG. 2B, the processor 208 may further comprise a service provider 222, an UPnP device 224, and an application 226. The service provider 222 can be used in a communication device at the service-provider side to provide a cross-platform service after the service demander of the first communication device 110 requests the service. The UPnP device 224 is used to transmit a notify message when receiving an M-search message from the UPnP control point 218. The application 226 can be launched by the service provider 222. The control circuit 206 may further execute the program code 212 in the memory 210 through the processor 208 to operate the service demander 216, the UPnP control point 218, the browser/first application 220, the service provider 222, the UPnP device 224, and the application 226. It is noted that the first communication device 110 and the second communication device 120 can be employed with an access terminal or mobile device, and can be, for instance, a module such as an SD card, a network card, a wireless network card, a computer (including laptops, desktops, personal digital assistants (PDAs)), mobile phones, smart phones, or any other suitable terminal that can be utilized to access a network.

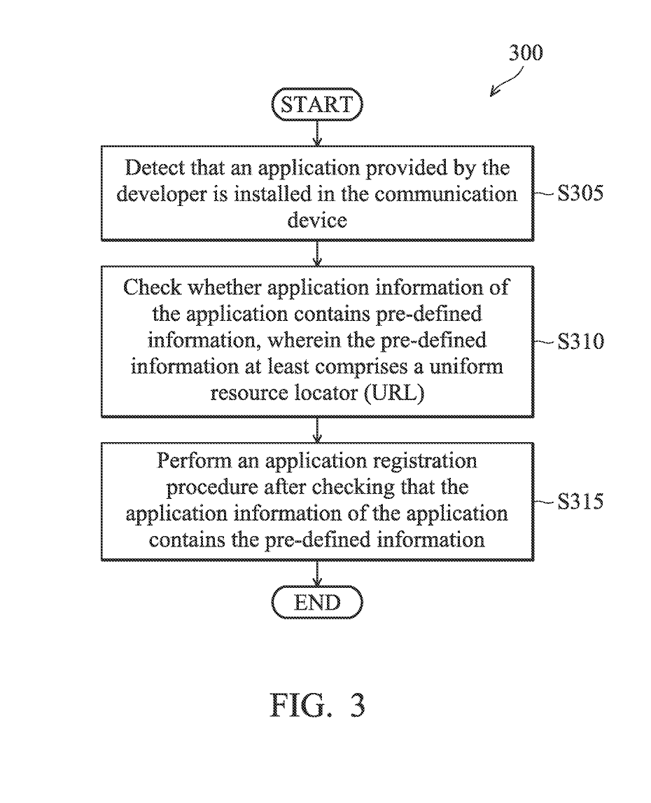

FIG. 3 is a flow diagram illustrating a method 300 for registering an application according to an embodiment of the present invention. It should be noted that the method is performed by a service provider of the communication device. The applications provided by a developer can be registered to the service provider by using the method 300. First, in step S305, the service provider detects that an application provided by the developer is installed in the communication device. Next, in step S310, the service provider checks whether application information of the application contains pre-defined information, wherein the pre-defined information at least comprises a uniform resource locator (URL), a uniform source identifier (URI), or header information. In step S315, the service provider performs an application registration procedure after checking that the application information of the application contains the pre-defined information.

In the embodiment, the service provider can generate a service list recording the services registered to the service provider after performing an application registration procedure. The service list can be stored in the memory 210 of FIG. 2B.

In another embodiment, the application may include metadata information. After detecting the metadata information, the service provider can read the application directly and complete the registration of the application.

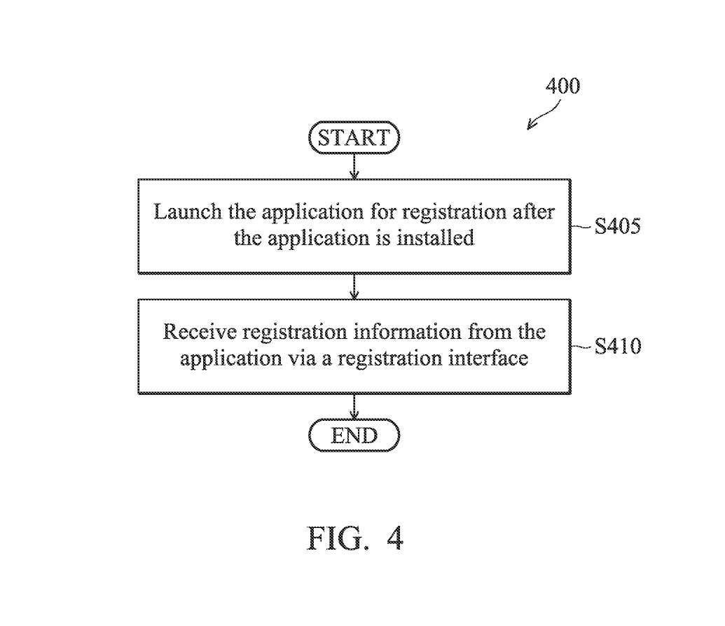

FIG. 4 is a flow diagram 400 illustrating the steps of performing an application registration procedure according to an embodiment of the invention. As shown, in step S405, the service provider launches the application for registration after the application is installed. In step S410, the service provider receives registration information from the application via a registration interface, such as an interprocess communications (IPC) interface, wherein the registration information comprises device/service information used to register the application.

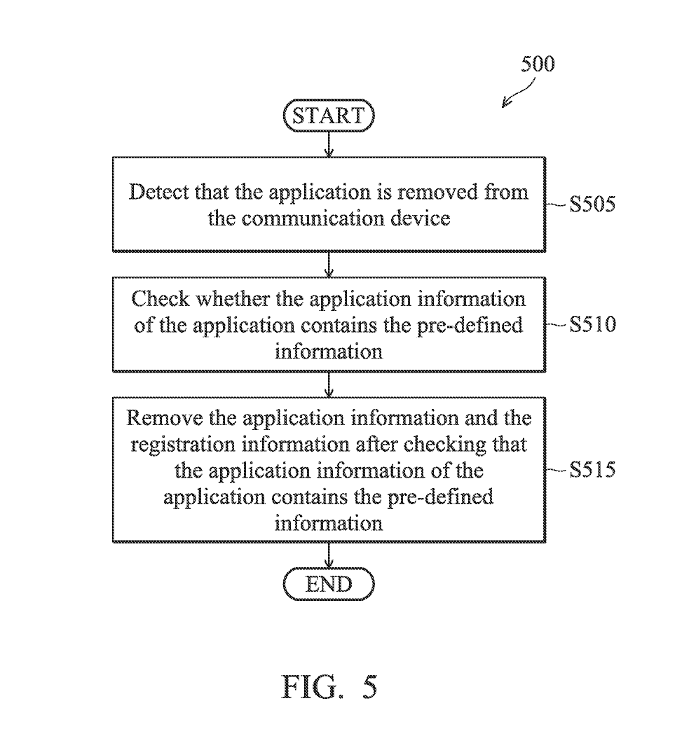

FIG. 5 is a flow diagram 500 illustrating the steps of removing an application registration procedure according to an embodiment of the invention. As shown, in step S505, the service provider detects that the application is removed from the communication device. Next, in step S510, the service provider checks whether the application information of the application contains the pre-defined information. In step S515, the service provider removes the application information and the registration information after checking that the application information of the application contains the pre-defined information.

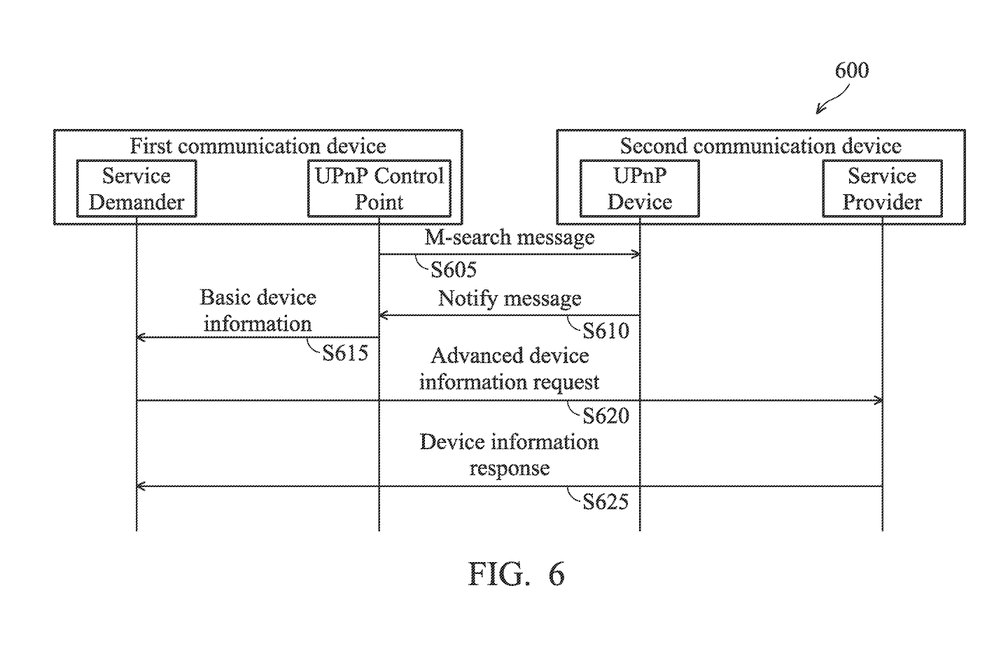

FIG. 6 illustrates a procedure 600 for cross-platform applications performed between a first communication device and a second communication device with reference to the communications system in FIG. 1 and the communication devices in FIGS. 2A˜2B according to an embodiment of the invention. The method 600 describes that how the first communication device finds the second communication device, and how the second communication device publishes the service to the first communication device.

In step S605, a universal plug and play (UPnP) control point of the first communication device multicasts a Multicast-search (M-search) message. Then, in step S610, the UPnP device of the second communication device transmits a notify message including an IP address of the second communication device to the UPnP control point. Next, in step S615, the UPnP control point transmits basic device information to the service demander of the first communication device according to the notify message, wherein the basic device information at least includes the IP address of the second communication device. In step S620, the service demander of the first communication device transmits an advanced device information request to the service provider of the second communication device for requesting advanced device information according to the IP address via the network, for example such as a TCP/IP network, UDP, HTTP, etc. In step S625, the service provider of the second communication device transmits a device information response including the advanced device information to the service demander of the first communication device after receiving the advanced device information request, wherein the advanced device information at least includes a service list and the details information of the services. It should be noted that although the service discovery between proximity devices is performed via the Simple Service Discovery Protocol (SSDP) protocol of the UPnP control point in the invention, Bonjour (mDNS) protocol can also be used for service discovery.

According to different access requirements of the first communication device, the second communication device can launch an APP mapping to a service requested by the service demander of the first communication device by the following two types:

Type 1:

In Type 1, the first communication device can use a browser to access the service of the second communication device.

Type 2:

In Type 2, the first communication device can use a first application to access the service of the second communication device.

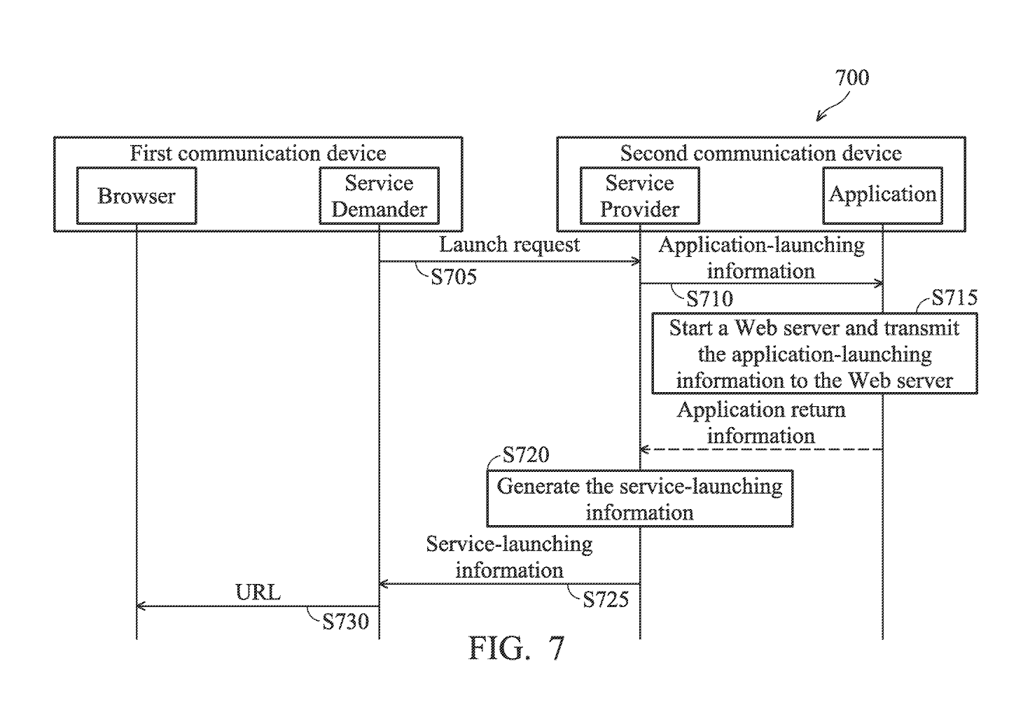

FIG. 7 illustrates a procedure 700 for launching cross-platform applications performed between a first communication device and a second communication device with reference to the communications system in FIG. 1 and the communication devices in FIGS. 2A˜2B according to an embodiment of the invention. The procedure 700 of FIG. 7 uses Type 1.

In step S705, the service demander of the first communication device transmits a launch request to the service provider of the second communication device for launching a service related to a Web via the network, such as a TCP/IP network, UDP, HTTP, etc. It should be noted that the service related to the Web is recorded in the service list stored in the second communication device. In step S710, the service provider launches the application mapped to the service and transmits application-launching information to the application, wherein the application-launching information at least includes launch parameters and an IP address of the first communication device. Then, in step S715, the application can start a Web server according to the launch request, and transmits the application-launching information to the Web server. Next, in step S720, the service provider can generate the service-launching information according to registration information received from the application in FIG. 4 during an application registration procedure. In another case (e.g., depicted by dotted lines between step S715 and step S720), the Web server or the application may generate application return information, wherein the application return information at least includes a uniform resource locator (URL) and parameters of the service. Then, the application transmits the application return information to the service provider. The service provider may generate the service-launching information according to the application return information transmitted by the application.

Next, in step S725, the service provider transmits the service-launching information to the service demander of the first communication device. In step S730, the service demander transmits the URL to the browser and opens the browser to access the service according to the URL of the service-launching information.

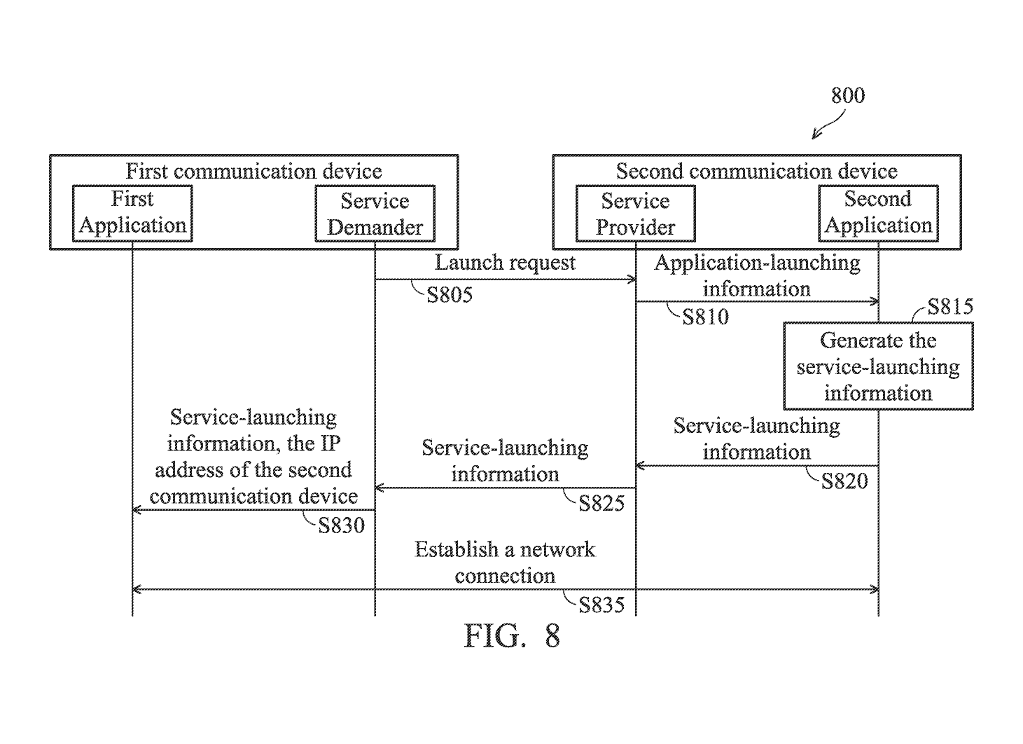

FIG. 8 illustrates a procedure 800 for launching cross-platform applications performed between a first communication device and a second communication device with reference to the communications system in FIG. 8 and the communication devices in FIGS. 2A˜2B according to an embodiment of the invention. The procedure 800 of FIG. 8 uses Type 2.

In step S805, the service demander of the first communications transmits a launch request to the service provider of the second communication device for launching the service of the second communication device via the network, such as a TCP/IP network, UDP, HTTP, etc. It should be noted that the service is recorded in the service list stored in the second communication device. In step S810, the service provider launches the second application mapped to the service and transmits application-launching information to the second application, wherein the application-launching information at least includes launch parameters and an IP address of the first communication device. Then, in step S815, the second application can generate the service-launching information, wherein the service-launching information at least includes a launch path and parameters of the service. In step S820, the second application transmits the service-launching information to the service provider, wherein the service-launching information at least includes a launch path and parameters of the service. In step S825, the service provider transmits the service-launching information to the service demander of the first communication device. In step S830, the service demander starts up the first application to access the service according to the launch path and transmits the service-launching information and the IP address of the second communication device to the first application. In step S835, the first application establishes a network connection with the second application of the second communication device according to an IP address of the first communication device and the IP address of the second communication device to launch the service through the first application.

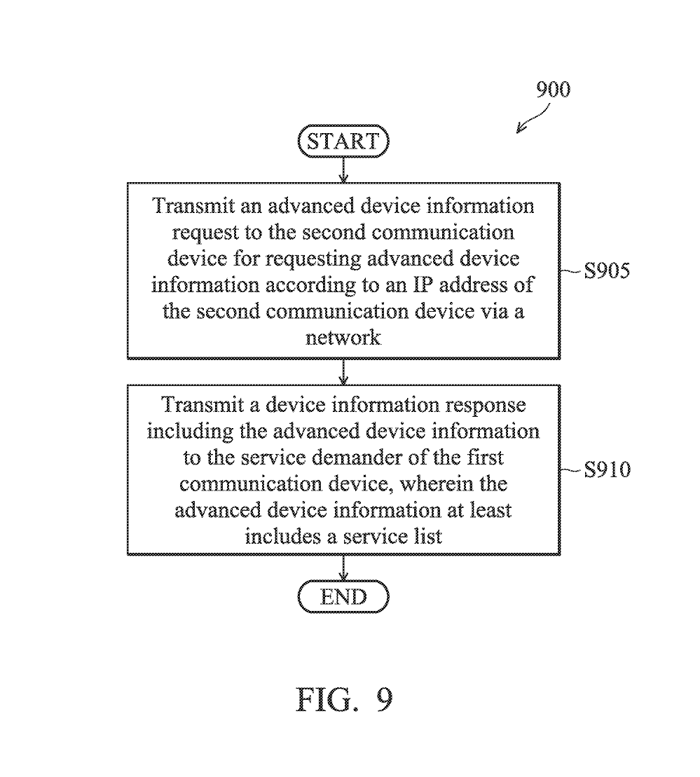

FIG. 9 is a flow diagram 900 illustrating the second communication device publishes the service to the first communication device according to an embodiment of the invention. In step S905, the service demander of the first communication device transmits an advanced device information request to the second communication device for requesting advanced device information according to an IP address of the second communication device via a network. In step S910, a service provider of the second communication device transmits a device information response including the advanced device information to the service demander of the first communication device, wherein the advanced device information at least includes a service list.

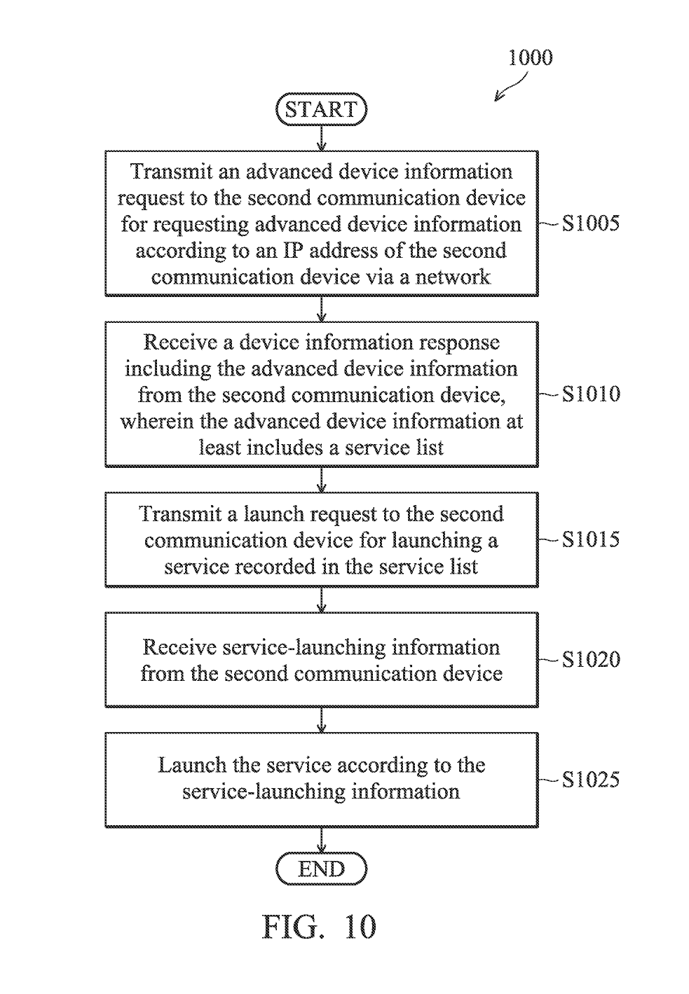

FIG. 10 is a flow diagram 1000 illustrating a method for accessing a cross-platform service according to an embodiment of the invention, wherein the method is used in the first communication device of FIG. 2. In step S1005, the first communication device transmits an advanced device information request to the second communication device for requesting advanced device information according to an IP address of the second communication device via a network. In step S1010, the first communication device receives a device information response including the advanced device information from the second communication device, wherein the advanced device information at least includes a service list. Then, in step S1015, the first communication device transmits a launch request to the second communication device for launching a service (i.e., browser or app) recorded in the service list. Next, in step S1020, the first communication device receives service-launching information from the second communication device. In step S1025, the first communication device launches the service according to the service-launching information.

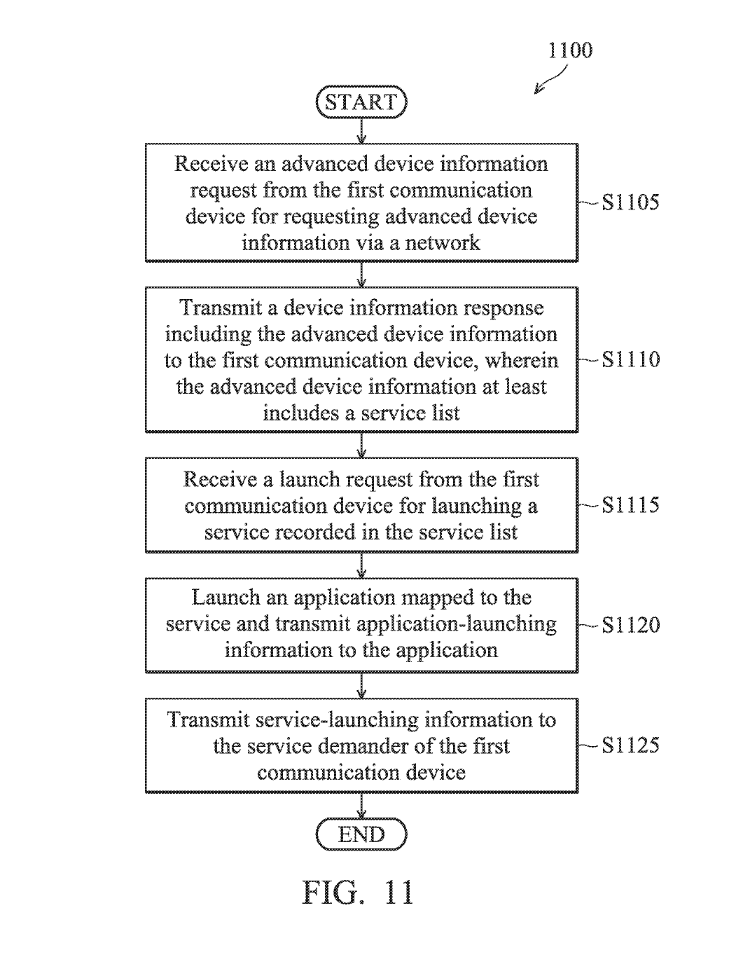

FIG. 11 is a flow diagram 1100 illustrating a method for accessing a cross-platform service according to an embodiment of the invention, wherein the method is used in the second communication device of FIG. 2. In step S1105, the second communication device receives an advanced device information request from the first communication device for requesting advanced device information via a network. Next, in step S1110, the second communication device transmits a device information response including the advanced device information to the first communication device, wherein the advanced device information at least includes a service list. Then, in step S1115, the second communication device receives a launch request from the first communication device for launching a service recorded in the service list. In step S1120, the second communication device launches an application mapped to the service and transmits application-launching information to the application. In step S1125, the second communication device transmits service-launching information to the service demander of the first communication device.

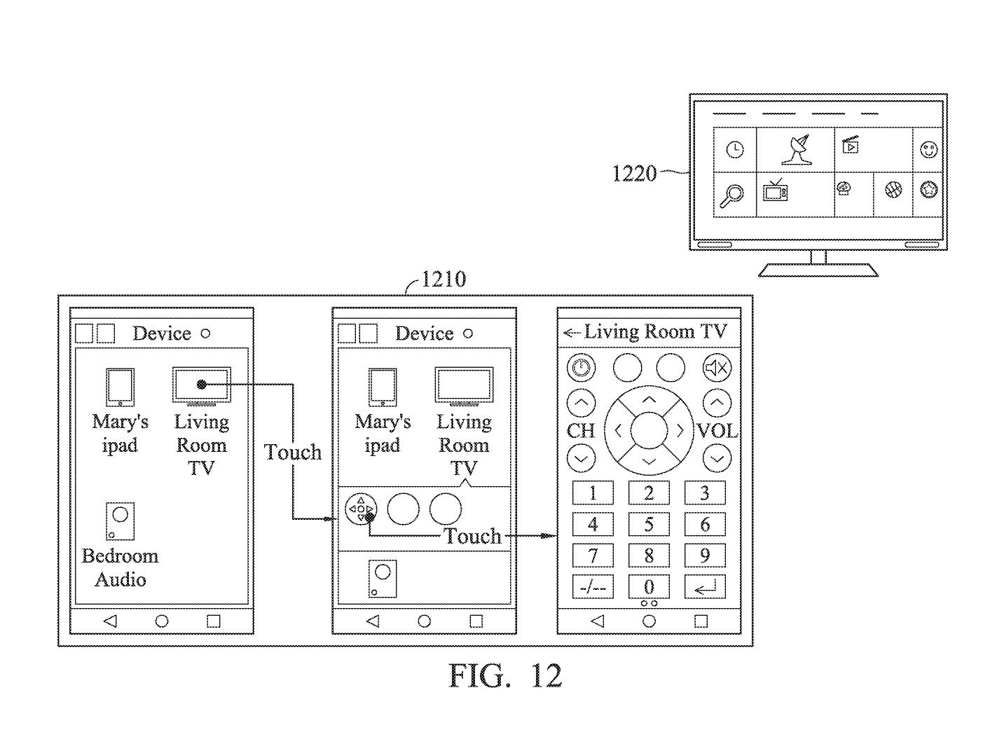

FIG. 12 is schematic diagram illustrating how a mobile phone 1210 used by a user accesses the service of a TV 1220 through a browser according to an embodiment of the invention. The mobile phone 1210 operates as the first communication device in FIG. 7, and the TV 1220 operates as the second communication device in FIG. 7. The user can touch an icon “Living Room TV” and choose one service “Controller” to transmit a launch request to the TV 1220 for launching a Web page. Then, the mobile phone 1210 can open the browser to access the service according to an URL transmitted from the TV 1220 after the TV 1220 transmits service-launching information. Finally, the TV 1220 can publish the Web page.

In another embodiment, the mobile phone 1210 also operates as the first communication device in FIG. 8, and the TV 1220 operates as the second communication device in FIG. 8. The mobile phone 1210 can start an application to access the service of the TV. The mobile phone 1210 can communicate with the TV through the application.

Thus, embodiments described herein create a communications system, a communication device and a method for accessing a cross-platform service in a wireless communications system. The cross-platform services can only be installed at the communication device at the service-provider side, and the communication device at the service-demander side can uses an application or a browser to access the service at the service-provider side, based on the embodiments described, herein. Overall, embodiments described herein allow users to access any application service on any device easily and with low-cost of resources.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

Those with skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those with skill in the art will further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It should be understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A communications system for accessing a cross-platform service, comprising:
a first communication device, comprising:
a service demander, transmitting an advanced device information request to a second communication device for requesting advanced device information according to an IP address of the second communication device via a network; and
the second communication device, comprising:
a service provider, transmitting a device information response including the advanced device information to the service demander of the first communication device,
wherein the advanced device information at least includes a service list.

2. The communications system for accessing a cross-platform service as claimed in claim 1, the second communication device further comprises:
an application, mapping to a service recorded in the service list;
wherein the service demander transmits a launch request to the second communication device for launching the service; the service provider launches the application mapped to the service, transmits application-launching information to the application, and transmits service-launching information to the service demander of the first communication device; and the service demander launches the service according to the service-launching information.

3. The communications system for accessing a cross-platform service as claimed in claim 2, wherein the service-launching information at least includes an uniform resource locator (URL) and parameters of the service.

4. The communications system for accessing a cross-platform service as claimed in claim 3, wherein the second communication device further comprises:
a Web server;
wherein the application starts the Web server and transmits the application-launching information to the Web server.

5. The communications system for accessing a cross-platform service as claimed in claim 4, wherein the service provider further generates the service-launching information according to registration information received from the application during an application registration procedure before transmitting the service-launching information.

6. The communications system for accessing a cross-platform service as claimed in claim 4, wherein the service provider generates the service-launching information according to application return information transmitted by the application before transmitting the service-launching information,
wherein the application return information at least includes the URL and the parameters of the service.

7. The communications system for accessing a cross-platform service as claimed in claim 3, wherein the service demander opens a browser to access the service according to the URL after receiving the service-launching information.

8. The communications system for accessing a cross-platform service as claimed in claim 2, wherein after the service provider launches the application, the application generates the service-launching information and transmits the service-launching information to the service provider,
wherein the service-launching information at least includes a launch path and parameters of the service.

9. The communications system for accessing a cross-platform service as claimed in claim 8, wherein after the service provider transmits the service-launching information, the service demander starts up a first application to access the service according to the launch path and transmits the service-launching information and the IP address of the second communication device to the first application; the first application establishes a network connection with the application of the second communication device according to an IP address of the first communication device and the IP address of the second communication device to launch the service through the first application.

10. The communications system for accessing a cross-platform service as claimed in claim 2, wherein the application-launching information at least includes launch parameters and an IP address of the first communication device.

11. The communications system for accessing a cross-platform service as claimed in claim 2, wherein the service list includes a list of services mapped to respective applications.

12. A communication device for accessing a cross-platform service, comprising:
a memory; and
a processor, comprising:
a service provider, detecting that an application is installed in the communication device, checking whether application information of the application contains pre-defined information and performing an application registration procedure after checking that the application information of the application contains the pre-defined information.

13. The communication device for accessing a cross-platform service as claimed in claim 12, the application registration procedure performed by the service provider further comprising:
launching the application for registration; and
receiving registration information from the application via a registration interface, wherein the registration information comprises device/service information used to register the application.

14. The communication device for accessing a cross-platform service as claimed in claim 12, wherein the pre-defined information at least comprises a uniform resource locator (URL), a uniform source identifier (URI), or header information.

15. The communication device for accessing a cross-platform service as claimed in claim 12, the application registration procedure performed by the service provider further comprises:
detecting that the application is removed from the communication device;
checking whether the application information of the application contains the pre-defined information; and
removing the application information and the registration information after checking that the application information of the application contains the pre-defined information.

16. A method for accessing a cross-platform service, used in a communications system, comprising:
transmitting, by a service demander of a first communication device, an advanced device information request to a second communication device for requesting advanced device information according to an IP address of the second communication device via a network; and
transmitting, by a service provider of the second communication device, a device information response including the advanced device information to the service demander of the first communication device,
wherein the advanced device information at least includes a service list.

17. The method for accessing a cross-platform service as claimed in claim 16, further comprising:
transmitting, by the service demander, a launch request to the second communication device for launching a service recorded in the service list;
launching, by the service provider, an application mapped to the service and transmitting application-launching information to the application;
transmitting, by the service provider, service-launching information to the service demander of the first communication device; and
launching, by the service demander, the service according to the service-launching information.

18. The method for accessing a cross-platform service as claimed in claim 17, wherein the service-launching information at least includes a uniform resource locator (URL) and parameters of the service.

19. The method for accessing a cross-platform service as claimed in claim 18, wherein the following steps are performed after launching the application:
starting, by the application, a Web server and transmitting the application-launching information to the Web server.

20. The method for accessing a cross-platform service as claimed in claim 19, wherein the following steps are performed before transmitting the service-launching information:
generating, by the service provider, the service-launching information according to registration information received from the application during an application registration procedure.

21. The method for accessing a cross-platform service as claimed in claim 19, wherein the following steps are performed before transmitting the service-launching information:
generating, by the service provider, the service-launching information according to application return information transmitted by the application before transmitting the service-launching information,
wherein the application return information at least includes the URL and the parameters of the service.

22. The method for accessing a cross-platform service as claimed in claim 18, wherein the following steps are performed after the service provider transmits the service-launching information:
opening, by the service demander, a browser to access the service according to the URL.

23. The method for accessing a cross-platform service as claimed in claim 17, wherein the following steps are performed after launching the application:
generating, by the application, service-launching information and transmitting the service-launching information to the service provider,
wherein the service-launching information at least includes a launch path and parameters of the service.

24. The method for accessing a cross-platform service as claimed in claim 23, wherein the following steps are performed after the service provider transmits the service-launching information:
starting up, by the service demander, a first application to access the service according to the launch path and transmitting the service-launching information and the IP address of the second communication device to the first application;
establishing, by the first application, a network connection with the application of the second communication device according to an IP address of the first communication device and the IP address of the second communication device to launch the service through the first application.

25. The method for accessing a cross-platform service as claimed in claim 17, wherein the application-launching information at least includes launch parameters and an IP address of the first communication device.

26. The method for accessing a cross-platform service as claimed in claim 17, wherein the service list includes a list of services mapped to respective applications.

27. A method for accessing a cross-platform service, used in a communication device, comprising:
detecting that an application is installed in the communication device;
checking whether application information of the application contains pre-defined information; and
performing an application registration procedure when checking that the application information of the application contains the pre-defined information.

28. The method for accessing a cross-platform service as claimed in claim 27, wherein the application registration procedure further comprises:
launching the application for registration; and
receiving a registration information from the application via a registration interface,
wherein the registration information comprises device/service information used to register the application.

29. The method for accessing a cross-platform service as claimed in claim 27, wherein the pre-defined information at least comprises a uniform resource locator (URL), a uniform source identifier (URI), or header information.

30. The method for accessing a cross-platform service as claimed in claim 27, wherein the application registration procedure further comprises:
detecting that the application is removed from the communication device;
checking whether the application information of the application contains the pre-defined information; and
removing the application information and the registration information after checking that the application information of the application contains the pre-defined information.

31. A method for accessing a cross-platform service, used in a communication device, comprising:
transmitting an advanced device information request to a second communication device for requesting advanced device information according to an IP address of the second communication device via a network;
receiving a device information response including the advanced device information from the second communication device, wherein the advanced device information at least includes a service list;
transmitting a launch request to the second communication device for launching a service recorded in the service list;
receiving service-launching information from the second communication device; and
launching the service according to the service-launching information.

32. The method as claimed in claim 31, wherein the service-launching information at least includes an uniform resource locator (URL) and parameters of the service.

33. A method for accessing a cross-platform service, used in a communication device, comprising:
receiving an advanced device information request from a first communication device for requesting advanced device information via a network;
transmitting a device information response including the advanced device information to the first communication device, wherein the advanced device information at least includes a service list;
receiving a launch request from the first communication device for launching a service recorded in the service list;
launching an application mapped to the service and transmitting application-launching information to the application; and
transmitting service-launching information to the service demander of the first communication device.

34. The method as claimed in claim 33, wherein the service-launching information at least includes a uniform resource locator (URL) and parameters of the service.
